(19) United States
(12) Patent Application Publication
(10) Pub. No.: US 2014/0227653 A1
(43) Pub. Date: Aug. 14, 2014

(54) Coated Orthodontic Appliance

(71) Applicant: SPIRE CORPORATION, Bedford, MA (US)

(72) Inventors: Nader M. Kalkhoran, Tewksbury, MA (US); Eric Tobin, North Andover, MA (US); Jason Burns, Cambridge, MA (US)

(73) Assignee: SPIRE CORPORATION, Bedford, MA (US)

(21) Appl. No.: 13/764,917

(22) Filed: Feb. 12, 2013

(51) Int. Cl. A61C 7/20; A61C 7/14

(52) U.S. Cl. CPC A61C 7/20; A61C 7/14
USPC 433/8; 433/20; 433/2; 427/2.29

(57) ABSTRACT

A ceramic coated aesthetic orthodontic appliance is described as well as methods for making one. The appliance can be an archwire or a bracket. The ceramic coated aesthetic appliance can include an orthodontic archwire having a surface, an aesthetic coating covering at least a portion of the surface, and a ceramic coating layer covering at least a portion of the aesthetic coating. The aesthetic coating can be an aesthetic polymer coating and the ceramic coating layer can be deposited using a low temperature process such as ion beam assisted deposition. An ion beam surface cleaning step may also be added to enhance the adhesion of the ceramic coating layer.

### FIELD

The present invention relates to coated orthodontic appliances and methods for making them.

### BACKGROUND

Archwires are an essential component of orthodontic treatment because they provide the forces necessary to correct irregularities in tooth positioning. They are available in a number of different materials, such as stainless steel, nickel-titanium, and titanium-molybdenum alloy. Archwires are also available in a wide variety of cross-sectional geometries and different force characteristics. The elasticity or springback characteristics of the archwire can be particularly important. The term elasticity can encompass the strength, stiffness and range of the device where strength=stiffness×range. Archwires provide orthodontists with a great amount of flexibility during the various states of orthodontic treatment.

Although modern archwires are very effective in providing desired mechanical forces and achieving the objectives of tooth alignment, the vast majority are metal and, therefore, not aesthetically pleasing next to ivory colored teeth. Patients would much prefer wires that are either clear or closer in coloration and appearance to their teeth, and in fact, many would be willing to pay more for such wires. This is particularly true in the adult orthodontic market. Both clear and tooth colored archwires are available commercially to address this market demand. For instance, BioMers Products of Naples, Fla. offers a translucent arch wire composed of a glass fiber-reinforced polymer composite resin under the name SIMPLICLEAR. Many other companies offer white or off-white archwires, which utilize polymeric or other material coatings to cover the metal surface of the archwire. For example, Dentsply GAC International of Bohemia, N.Y. offers HIGH AESTHETIC ARCHWIRES, which are coated with a “frosted” Rhodium coating that reduces the metallic reflections of the metal archwire. Acme Monaco of New Britain, Conn. offers MICRO DENTAL WHITE ARCHWIRES, which utilize 0.0015 inch thick Polytetrafluoroethylene (PTFE) coatings applied to the labial surface of the archwire.

Despite their favorable appearance, these archwires have a number of problems that prevent widespread adoption. For instance, they either do not provide ideal force characteristics or are prone to breakage, or both. In the case of coated wires, the coatings can wear away or delaminate before the wire has reached its functional lifetime, revealing the underlying metal wire. An ideal solution has yet to be developed.

Similar problems can arise for the brackets to which the archwires are engaged (the archwires and brackets collectively are referred to herein as “orthodontic appliances”). These brackets can be formed of polycrystalline alumina, for example, but the ceramic brackets do not perform as well as traditional metal brackets. Accordingly, a solution that could be applied to both archwires and brackets (orthodontic appliances) would be beneficial.

### SUMMARY

The invention provides ceramic coated aesthetic orthodontic appliances. In a first aspect, a ceramic coated aesthetic archwire is provided. The ceramic coated aesthetic archwire includes an orthodontic archwire, an aesthetic coating on at least a portion of the orthodontic archwire's surface, and a protective ceramic coating layer provided over at least a portion of the aesthetic coating.

In a further aspect, a method for preparing a ceramic coated aesthetic archwire is provided. In the method, an orthodontic archwire having a surface and an aesthetic coating provided on at least a portion of the orthodontic archwire surface is provided. A ceramic coating layer is then deposited over at least a portion of the aesthetic coating.

In a still further aspect, a ceramic coated aesthetic orthodontic appliance is provided. The orthodontic applicant is provided with an aesthetic coating provided on at least a portion of the orthodontic appliance surface. A protective ceramic coating is further provided over at least a portion of the aesthetic coating.

In each of these aspects, a number of embodiments may be provided. The aesthetic coating can be an aesthetic polymer coating and it may be provided over a portion or all of the archwire or appliance. In some embodiments, the ceramic coating may also be provided over a portion or all of the archwire or appliance. The ceramic coating may have a thickness of between 0.1 and 20 microns. In other embodiments, the ceramic coating may have a thickness of between 0.1 and 6 microns. In still further embodiments, the ceramic coating may have a thickness of between 0.5 and 2.0 microns. The ceramic coating material can be selected from among aluminum oxide, zirconium oxide, or titanium oxide, or it can be selected from among aluminum oxide, zirconium oxide, titanium oxide, or a diamond-like carbon. In some embodiments, the ceramic coating can be translucent.

In certain embodiments, the protective ceramic coating layer is formed using a low temperature process. The protective ceramic coating layer can also be formed using ion beam assisted deposition. Still further, the ion beam deposition process can include an ion beam surface cleaning step.

### BRIEF DESCRIPTION OF THE DRAWINGS

The invention will be more fully understood from the following detailed description taken in conjunction with the accompanying drawings, in which:

FIG. 1 is a cross-sectional view of a round ceramic coated aesthetic archwire of the invention;

FIG. 2 is a cross-sectional view of a rectangular ceramic coated aesthetic archwire of the invention;

FIG. 3 is a cross-sectional view of a rectangular ceramic coated aesthetic archwire of the invention where the ceramic coating is applied to a portion of the archwire;

FIG. 4 is a functional block diagram depicting a process for depositing the ceramic coating of FIGS. 1, 2, and 3; and

FIG. 5 is a perspective view of a brace to which coatings may be applied.

### DETAILED DESCRIPTION

Systems and methods are provided herein that generally involve providing a protective ceramic coating that can maintain the white or off-white appearance of an underlying aesthetic polymeric coating on orthodontic appliances. For archwires, the resulting product is an orthodontic archwire that includes an underlying wire, typically made of metal, a polymeric coating on the wire that is of the desired color, and a clear ceramic coating layer over the polymeric coating that can protect the colored polymeric coating. The protective ceramic layer can be deposited using a thin film process that does not adversely affect the adhesion or color of the polymeric coating, and that also does not adversely affect the mechanical properties of the archwire—in particular, the wire's stiffness or shape memory properties. Preferable ceramic coating techniques include low temperature vacuum deposition processes such as ion beam assisted deposition (IBAD).

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

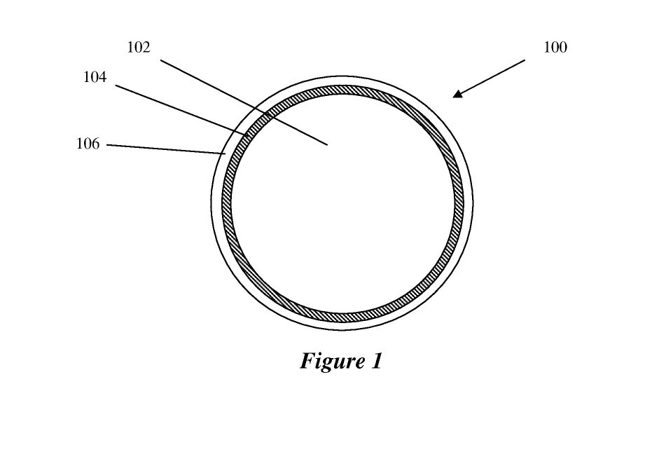

FIG. 1 provides a cross-sectional illustration of one exemplary embodiment of a ceramic coated aesthetic archwire 100. The system generally includes an orthodontic archwire 102 that provides the forces required by the orthodontist. An aesthetic coating 104, typically colored as desired, is provided on the archwire 102. A protective ceramic layer 106 is provided over the aesthetic coating.

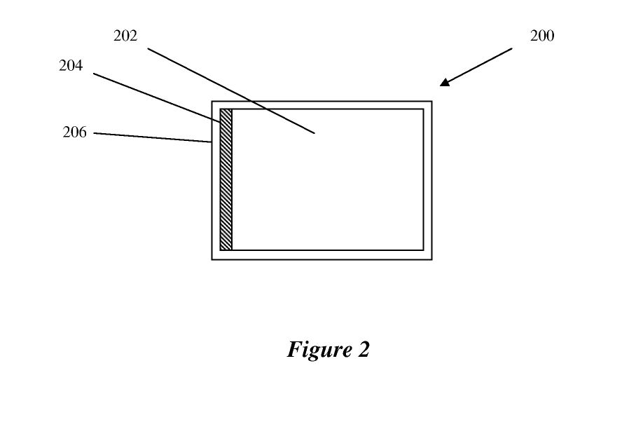

FIG. 2 provides a cross-sectional illustration of a further exemplary embodiment of a ceramic coated aesthetic archwire 200. The system generally includes an orthodontic archwire 202 that provides the forces required by the orthodontist. In this example, the archwire is rectangular where archwire 102 in FIG. 1 is circular. An aesthetic coating 204, typically colored as desired, is provided on the archwire 202. In this embodiment, the aesthetic polymer coating is provided on only one face of the rectangular archwire. A protective ceramic layer 206 is provided over the aesthetic polymer coated archwire.

An upper or lower orthodontic brace generally includes a plurality of brackets and an archwire such as archwire 102 or archwire 202. Each bracket is bonded to a single tooth of the upper or lower dental arch and the arch wire extends around the arch to engage with each bracket. The forces applied by the archwire on the teeth through the brackets allow an orthodontist to move a patient's teeth for the purpose of aligning or straightening them. The physical characteristics of the archwire, especially its strength and stiffness, are thus very important to its use. Orthodontists typically change the archwires over time in order to change the strength and stiffness of the wires in order to vary the force applied to the patient's teeth at different points in the straightening process.

Archwires are typically characterized by their cross-sectional geometry, their size, and their material. The cross-sectional geometry of an archwire is typically round or circular, such as archwire 102 of FIG. 1, or square or rectangular, such as archwire 202 of FIG. 2. Round archwires commonly have a diameter of between 0.010 and 0.022 inches. Rectangular archwires commonly have dimensions of 0.010 to 0.028 inches. Archwires are typically formed of stainless steel, nickel-titanium, or beta-titanium.

Aesthetic coating 104, 204 can be applied to coat the entire outer surface of the archwire, as illustrated in FIG. 1, or to a portion of the archwire as illustrated in FIG. 2 where only the labial facing surface of the rectangular archwire is coated. In one embodiment, the aesthetic coating is an aesthetic polymeric coating. Other aesthetic coatings are possible with the invention, such as the Rhodium coating described in the background. Because the aesthetic polymeric coating is one of the more difficult aesthetic coatings over which to provide the protective ceramic layer, aesthetic polymeric coatings are addressed in the remainder of the disclosure. The aesthetic polymeric coating material can be formed from any polymeric material that can be pigmented or otherwise colored. The aesthetic polymeric coating also preferably has little or no impact on the strength characteristics of the archwire. In a preferred embodiment, the aesthetic polymeric coating can be formed of polytetrafluoroethylene (PTFE).

The thickness of the aesthetic polymeric coating should be sufficient to impart the desired aesthetic effect, and generally as thin as possible otherwise. In one exemplary embodiment, aesthetic polymer coating 104, 204 is a 0.015 inch thick PTFE coating.

Ceramic coating layer 106, 206 covers at least the aesthetic polymer 104, 204, and may cover the entire archwire 102, 202 even if the aesthetic polymer does not. The ceramic coating layer should not interfere with the aesthetic effect of the polymer, and preferably is clear. The ceramic coating layer also preferably assists with the sliding mechanics of the archwire within the brackets that hold it. In general, this can be accomplished using dense coatings. In general, the ceramic coating layer could be formed from any biocompatible ceramic material, including metal oxides, metal nitrides, and diamond-like carbon, however, in preferred embodiments the ceramic coating layer is selected from among metal oxides such as aluminum oxide, zirconium oxide, or titanium oxide.

It is also important that the ceramic coating layer adhere very strongly to the aesthetic polymer while not adversely affecting the aesthetic polymer. Perhaps more importantly, the ceramic coating layer, and the process by which it is deposited should not adversely affect the characteristics of the archwire itself, especially the strength characteristics, as orthodontists depend on those characteristics for the purposes of straightening their patients' teeth. In preferred embodiments, this can be accomplished with thin coatings. In some cases, the coatings can be between 0.1 and 20 microns thick. More preferably, the coatings can be between 0.1 and 6.0 microns thick. Still more preferably, the coatings can be between 0.5 and 2.0 microns thick.

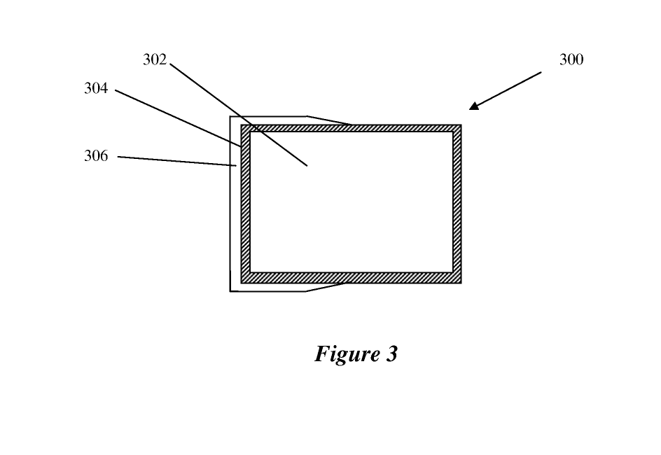

In some embodiments, the protective ceramic coating layer can cover only a portion of the aesthetic coating layer. This embodiment is illustrated in FIG. 3 which shows rectangular archwire 300. The metallic archwire 302 in this embodiment is completely covered with an aesthetic coating layer 304, which in turn is only partially covered by a protective ceramic layer 306. This construct might be advantageous, for example, where the process for providing the aesthetic coating layer is more easily performed to coat the entire archwire, but only the portion of the archwire that will be visible during use needs to be protected with a protective ceramic coating.

Applying the ceramic coating layer using a low temperature deposition process can also be important to preserving the characteristics of the archwire and the aesthetic polymer coating. Archwire materials can be sensitive to elevated temperatures, which can embrittle the wires, or affect their shape memory or super-elastic properties. In some embodiments, “low temperature” as used herein can mean processes that operate at less than or equal to 300° C. In other embodiments, “low temperature” can mean processes that operate at less than 200° C. In still other embodiments, “low temperature” can mean processes that operate at less than 100° C. Coating at these low temperatures can prevent or reduce discoloration of the aesthetic polymer coating layer and prevent or reduce changes to the characteristics of the archwire.

The protective ceramic coating can be applied in a number of processes, including deposition processes such as vacuum deposition or physical vapor deposition. One particularly preferred low temperature process for applying the ceramic coating layer is ion beam assisted deposition (IBAD). Ion beam processes are low-temperature, high-technology processes with excellent quality control to achieve good reproducibility, reliability and thickness of deposition control at a high throughput and with no chemical residues, thus being both environmentally and occupationally a safe, dependable technique. The IBAD process can thus produce a very dense, non-porous, biocompatible coating that can help resist staining of the aesthetic polymeric coating from food and drink products.

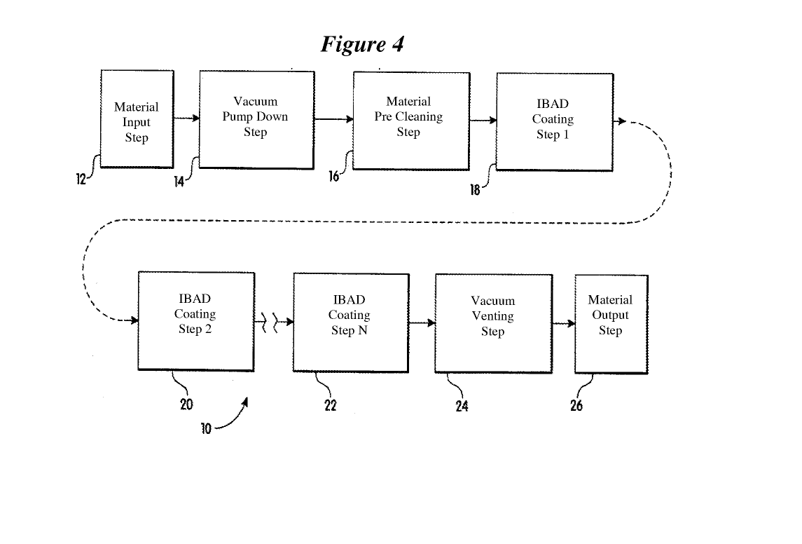

An exemplary IBAD process for providing the ceramic coating layer on the archwire is described by reference to FIG. 4. Processes of the invention need not conform strictly to the description provided below.

An IBAD process 10 for archwires is described by reference to the functional block diagram of FIG. 4. Essentially, the IBAD process 10 comprises a material input step 12, a vacuum pump-down step 14, a material pre-cleaning step 16, an ion-beam assisted coating stage which may comprise one or more than one IBAD process steps 18, 20 and 22, a vacuum venting step 24, and a material output step 26. Generally, it is expected that the archwires will be shaped prior to coating and will be coated as individual pieces. It is also possible that the wire could be continuously coated, then cut and shaped later. It is further possible that the wire could be shaped and continuous during the coating process followed by cutting into individual archwires.

During the material input 12 portion of the process, a workpiece (one or more archwires) can be loaded into a holder. The holder is then placed into a vacuum chamber, which is evacuated to a suitable deposition pressure.

The material pre-cleaning step 16 can be implemented using a dedicated chamber having an ion beam source, or it can be implemented using the same ion beam source that is used for IBAD. In general, an ion source, such as a bucket type ion source, is deployed in a high vacuum operating environment for providing such a beam. One or more gases, such as argon, neon and/or helium (preferably argon for typical archwire materials), is fed to the ion source from a suitable gas supply source. The resulting ion beam can strip the surface of the workpiece to be coated of organic residues, particulates, oxides or other debris. The resultant atomically cleaned surface of the workpiece contributes significantly to the quality and density of the coating as well as to the adhesion of the coating to the workpiece. This cleaning may be of particular importance in adhering the ceramic coating to the aesthetic polymer portion of the archwire. Typically, the cleaning can be completed by ion bombardment extending over 2 to 15, or up to 30, minutes or more.

One or more IBAD steps 18, 20, 22 can be provided to form the ceramic coating layer. In general, each IBAD coating process step is conducted using an ion beam as well as an evaporator that provides the coating material. The evaporator is designed to vaporize particular metallic evaporants so as to dry coat the workpiece, with the ion beam emanating from the ion source assisting with the dry coating.

Following coating by the one or more IBAD modules, the workpiece can exit the high vacuum operating environment 24 and be retrieved from a material output section 26.

The thin ceramic coatings produced by these processes, using the materials and amounts as described above, can have a uniform thickness and can be characterized by being dense, free of pinholes, strongly adherent, hard yet flexible, clean and free of contaminants. Because the coatings are thin, and either amorphous or composed of very fine, nanocrystalline grains, the coating can exhibit significant ductility that allows the coating to continue to perform its desired functions as the archwire is deformed in use.

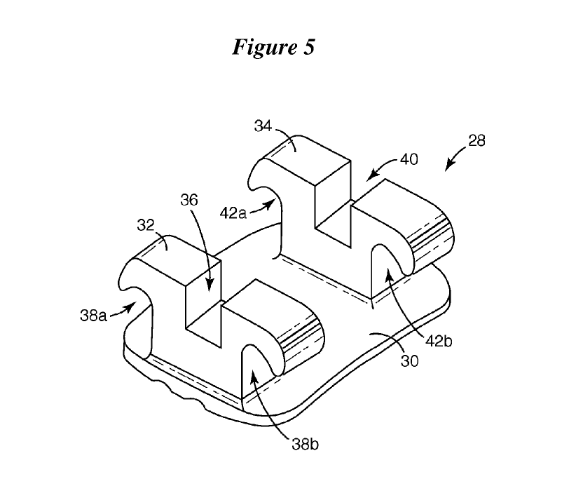

The techniques described above can also be applied to aesthetic orthodontic brackets. One exemplary bracket 28 is illustrated in FIG. 5. Exemplary bracket 28 includes base 30 and tie-wings 32 and 34. Base 30 is the portion of bracket 22 that becomes bonded to a tooth surface. Tie-wings 32 and 34 are a pair of wing-like structures integrally connected to base 30 for retaining an archwire. The dimensions of tie-wing 32 define slot 36 and ligature recesses 38a and 38b. Similarly, the dimensions of tie-wing 34 define slot 40 and ligature recesses 42a and 42b. Slots 36 and 40 are the portions of bracket 28 that engage an archwire. Ligature recesses 38a, 38b, 42a, and 42b are configured to receive a standard elastomeric or wire ligature for retaining an archwire within slots 36 and 40.

In use, an orthodontist may place a portion of the archwire within slots 36 and 40. A ligature may then be placed over the archwire and into recesses 38a and 38b behind tie-wing 32 and recesses 42a and 42b behind tie-wing 34. This process can secure the archwire within slots 36 and 40.

As with the archwire described above, the metal bracket may be wholly or partially coated with an aesthetic coating that is colored so that the bracket will blend in better with the color of the patient's teeth than an untreated metal bracket would. The aesthetic coating for the bracket may be polymeric, and it could, for example, cover the entire bracket, cover only the labial facing portions of the bracket, or cover only some other portion of the bracket. A protective ceramic coating, like those that can be applied to the archwire and using the same processes, can be applied to cover the entire bracket, at least the portion of the bracket having an aesthetic coating, or only a portion of the bracket having an aesthetic coating.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A ceramic coated aesthetic archwire comprising:
an orthodontic archwire having a surface;
an aesthetic coating provided on at least a portion of the orthodontic archwire surface; and
a protective ceramic coating layer provided over at least a portion of the aesthetic coating.

2. The ceramic coated aesthetic archwire of claim 1, wherein the aesthetic coating is an aesthetic polymer coating.

3. The ceramic coated aesthetic archwire of claim 1, wherein protective ceramic coating layer is provided over the entire orthodontic archwire.

4. The ceramic coated aesthetic archwire of claim 2, wherein the aesthetic polymer coating is provided over the entire orthodontic archwire surface.

5. The ceramic coated aesthetic archwire of claim 1, wherein the protective ceramic coating is between 0.1 and 20 microns thick.

6. The ceramic coated aesthetic archwire of claim 1, wherein the protective ceramic coating layer is between 0.1 and 6 microns thick.

7. The ceramic coated aesthetic archwire of claim 1, wherein the protective ceramic coating layer is between 0.5 and 2.0 microns thick.

8. The ceramic coated aesthetic archwire of claim 1, wherein the protective ceramic coating layer is a metal oxide, a metal nitride, or a diamond-like carbon.

9. The ceramic coated aesthetic archwire of claim 1, wherein the protective ceramic coating layer is selected from among aluminum oxide, zirconium oxide, or titanium oxide.

10. The ceramic coated aesthetic archwire of claim 2, wherein the protective ceramic coating layer is formed using a low temperature process.

11. The ceramic coated aesthetic archwire of claim 2, wherein the protective ceramic coating layer is formed using ion beam assisted deposition.

12. The ceramic coated aesthetic archwire of claim 11, wherein the ion beam assisted deposition process includes an ion beam surface cleaning step.

13. The ceramic coated aesthetic archwire of claim 1, wherein the ceramic coating is provided over a portion of the archwire.

14. The ceramic coated aesthetic archwire of claim 1, wherein the ceramic coating is translucent.

15. A method for preparing a ceramic coated aesthetic archwire, comprising:
providing an orthodontic archwire having a surface, and an aesthetic coating provided on at least a portion of the orthodontic archwire surface;
depositing a ceramic coating layer over at least a portion of the aesthetic coating.

16. The method of claim 15, wherein the aesthetic coating is an aesthetic polymer coating.

17. The method of claim 16, wherein the depositing comprises a low temperature deposition step.

18. The method of claim 17, wherein the low temperature deposition step comprises ion beam assisted deposition.

19. The method of claim 18, further comprising a step of ion beam surface cleaning prior to depositing the ceramic coating layer.

20. The method of claim 15, wherein the ceramic coating layer is deposited to a thickness of between 0.1 and 6.0 microns.

21. The method of claim 15, wherein the ceramic coating layer is deposited to a thickness of between 0.5 and 2.0 microns.

22. The method of claim 15, wherein the ceramic coating layer is selected from among aluminum oxide, zirconium oxide, or titanium oxide.

23. A ceramic coated aesthetic orthodontic appliance comprising:
an orthodontic appliance having a surface;
an aesthetic coating provided on at least a portion of the orthodontic appliance surface; and
a protective ceramic coating layer provided at least over a portion of the aesthetic coating.

24. The ceramic coated aesthetic orthodontic appliance, wherein the orthodontic appliance is a bracket.

25. The ceramic coated aesthetic orthodontic appliance of claim 21, wherein the aesthetic coating is an aesthetic polymer coating.

26. The ceramic coated aesthetic orthodontic appliance of claim 22, wherein the protective ceramic coating layer is formed using a low temperature process.

27. The ceramic coated aesthetic orthodontic appliance of claim 23, wherein the protective ceramic coating layer is formed using ion beam assisted deposition.

28. The ceramic coated aesthetic orthodontic appliance of claim 27, wherein the ion beam assisted deposition process includes an ion beam surface cleaning step.

29. The ceramic coated aesthetic orthodontic appliance of claim 25, wherein the ceramic coating is provided over a portion of the orthodontic appliance.

30. The ceramic coated aesthetic orthodontic appliance of claim 25, wherein protective ceramic coating layer is provided over the entire orthodontic appliance.

31. The ceramic coated aesthetic orthodontic appliance of claim 23, wherein the protective ceramic coating is between 0.1 and 20 microns thick.

32. The ceramic coated aesthetic orthodontic appliance of claim 23, wherein the protective ceramic coating layer is between 0.1 and 6 microns thick.

33. The ceramic coated aesthetic orthodontic appliance of claim 23, wherein the protective ceramic coating layer is between 0.5 and 2.0 microns thick.

34. The ceramic coated aesthetic orthodontic appliance 23, wherein the protective ceramic coating layer is a metal oxide, a metal nitride, or a diamond-like carbon.
